(19) United States
(12) Patent Application Publication
(10) Pub. No.: US 2019/0096341 A1
(43) Pub. Date: Mar. 28, 2019

(54) METHOD, SYSTEM AND COMPUTER READABLE STORAGE MEDIUM FOR DRIVING LIQUID CRYSTAL DISPLAYS

(71) Applicant: Wuhan China Star Optoelectronics Technology Co., Ltd., Wuhan, Hubei (CN)

(72) Inventor: Guowei ZHA, Shenzhen, Guangdong (CN)

(21) Appl. No.: 15/742,348

(22) PCT Filed: Oct. 31, 2017
(86) PCT No.: PCT/CN2017/108689

§ 371 Date: Jan. 5, 2018

(30) Foreign Application Priority Data
Sep. 28, 2017 (CN) 201710898972.0

(51) Int. Cl. G09G 3/36

(52) U.S. Cl. CPC G09G 3/3607; G09G 2320/0233; G09G 2320/0646; G09G 2360/16; G09G 2320/0242

(57) ABSTRACT

A method for driving a liquid crystal display comprising transforming a first image signal input to a liquid crystal display to a second image signal including a gain, and obtaining a brightness gain of each pixel in an image displayed by the liquid crystal display according to the second image signal, to obtain a brightness gain matrix, calculating a color-shift threshold gain corresponding to a default color-shift threshold, calculating a high-brightness threshold gain corresponding to a default high-brightness threshold, according to the color-shift threshold gain and the high-brightness threshold gain, amending the brightness gain matrix, and according to the brightness gain matrix amended, driving the liquid crystal display. The technical solution can improve the utilization rate of the backlight of the liquid crystal display and simultaneously to improve the color shift issue due to uneven brightness gain. A system and a computer readable storage medium are also provided herein.

### RELATED APPLICATIONS

The present application is a National Phase of International Application Number PCT/CN2017/108689, filed Oct. 31, 2017, and claims the priority of China Application No. 201710898972.0, filed Sep. 28, 2017.

### FIELD OF THE DISCLOSURE

The disclosure relates to a display technical field, and more particularly to a method, a system and a computer readable storage medium for driving liquid crystal displays.

### BACKGROUND

The core of display technology is to reproduce the perception of real world through human eye. The display technology of LCD has advantages such as mature manufactures, low costs, high reliability, etc., however, the brightness of pixels in LCD cannot be controlled individually, and the backlight can merely provide a whole area illumination or a large area illumination. The backlight consumes 80% of the power of a display panel, but more than 90% of the illumination from backlight is blocked or absorbed, and has no contribution for the effective displaying brightness. Therefore, the utilization rate of backlight is very low. In general, compared to RGB displays, the brightness efficiency of unsaturated color of RGBW displays can be promoted to the level of 150% to 200%, however, the brightness efficiency of saturated color of RGBW displays would be decreased to about 75%. Therefore, the displaying content of saturated color would be dimming and low colorful for the sight of human eye objectively, thereby to occur uneven brightness gain and cause the color shift issue. The above issue limits the technology advantages of RGBW displays and limits the application of RGBW technology in high dynamic ranges (HDR) display technology.

### SUMMARY

The present invention provides a method, a system and a computer readable storage medium, for driving a liquid crystal display, to promote the utilization rate of backlight and to improve the color shift issue due to uneven brightness gain.

In the first respect, the embodiment of the present invention provides a method for driving the liquid crystal display. The method for driving the liquid crystal display comprises;

transforming a first image signal input to a liquid crystal display to a second image signal including a gain, and obtaining a brightness gain of each pixel in an image displayed by the liquid crystal display according to the second image signal, to obtain a brightness gain matrix;

according to a default color-shift threshold, calculating a color-shift threshold gain corresponding to the default color-shift threshold;

according to a default high-brightness threshold, calculating a high-brightness threshold gain corresponding to the default high-brightness threshold;

according to the color-shift threshold gain and the high-brightness threshold gain, amending the brightness gain matrix; and

according to the brightness gain matrix amended, driving the liquid crystal display.

In the second respect, a system for driving the liquid crystal displays is provided. The system for driving the liquid crystal displays comprises;

a transforming module, for transforming a first image signal input to a liquid crystal display to a second image signal including a gain, and obtaining a brightness gain of each pixel in an image displayed by the liquid crystal display according to the second image signal, to obtain a brightness gain matrix;

a first calculating module, according to a default color-shift threshold, for calculating a color-shift threshold gain corresponding to the default color-shift threshold;

a second calculating module, according to a default high-brightness threshold, for calculating a high-brightness threshold gain corresponding to the default high-brightness threshold;

an amending module, according to the color-shift threshold gain and the high-brightness threshold gain, for amending the brightness gain matrix; and

a driving module, according to the brightness gain matrix amended, for driving the liquid crystal display.

In the third respect, a computer readable storage medium with a program for driving the liquid crystal display stored therein is provided. The program is executed to perform the method provided in the first respect.

In the fourth respect, a computer program product is provided. The computer program product comprises a non-instantaneous computer readable storage medium for storing a computer program. The computer program is executed to have a computer perform the method provided in the first respect.

The embodiments of present invention have the following advantages,

Apparently, In the embodiments of the present invention, the steps of transforming the image signal of the liquid crystal display, calculating the brightness gain, and amending the brightness gain matrix by the combination of the default color-shift threshold and the default high-brightness threshold, are applied to improve the utilization rate of the backlight of the liquid crystal display and simultaneously to improve the color shift issue due to uneven brightness gain.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a flowing chart illustrating the steps of a method for driving a liquid crystal display in an embodiment of the present invention;

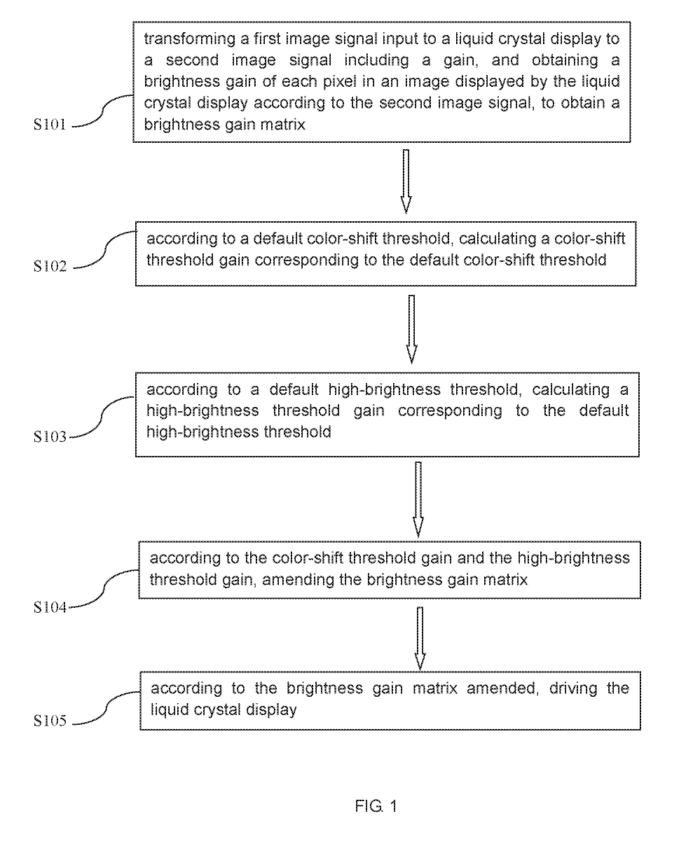

FIG. 2 is a structure scheme of a system for driving a liquid crystal display in an embodiment of the present invention;

FIG. 3 is a structure scheme of another system for driving a liquid crystal display in an embodiment of the present invention; and

FIG. 4 is a structure scheme of a system for driving a liquid crystal display in an embodiment of the present invention;

### DETAILED DESCRIPTION OF PREFERRED EMBODIMENTS

The disclosure will be further described in detail with reference to accompanying drawings and preferred embodiments as follows. The specific structural and functional details disclosed herein are only representative and are intended for describing exemplary embodiments of the disclosure. However, the disclosure can be embodied in many forms of substitution, and should not be interpreted as merely limited to the embodiments described herein. All other embodiments obtained by persons of ordinary skill in the art based on the embodiments of the present invention without creative efforts shall fall within the protection scope of the present invention.

The terms “first”, “second”, etc., in specification, claims and drawings of the invention, are used to distinguish between different objects, rather than describe a specific order. Furthermore, the terms “including” and “having”, and any modification thereof, are intended to cover non-exclusive inclusion. For example, a process, a method, a system, a product or an apparatus comprising a series of steps or units are not limited to the listed steps or units, but optionally further comprises more steps or units not listed, or optionally further comprises other inherent steps or units belong to such the process, the method, the product or the apparatus.

Reference herein to “one embodiment” , “an embodiment” , or “another embodiment” herein, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various features, structures, operations, or characteristics may be combined in any suitable manner in one or more embodiments.

For solving the above deficiency issues in operation, the present invention provides a method for driving the liquid crystal display. Specifically, in an embodiment, the method for driving the liquid crystal display comprises but not limited to the following steps.

Step S101 is transforming a first image signal input to a liquid crystal display to a second image signal including a gain, and obtaining a brightness gain of each pixel in an image displayed by the liquid crystal display according to the second image signal, to obtain a brightness gain matrix.

Step S102 is according to a default color-shift threshold, calculating a color-shift threshold gain corresponding to the default color-shift threshold.

In one embodiment, in the brightness gain matrix only a proportion of pixel gains are selected, the proportion is equal to the default color-shift threshold, and the selected pixel gains all are smaller than the color-shift threshold gain.

Step S103 is according to a default high-brightness threshold, calculating a high-brightness threshold gain corresponding to the default high-brightness threshold.

In one embodiment, in the brightness gain matrix only a proportion of pixel gains are selected, the proportion is equal to the default high-brightness threshold, and the selected pixel gains all are larger than the high-brightness threshold gain.

In one embodiment, the number of the default high-brightness threshold is at least one.

Step S104 is according to the color-shift threshold gain and the high-brightness threshold gain, amending the brightness gain matrix,

In one embodiment, when the brightness gain in the brightness gain matrix is smaller than the default color-shift threshold, the brightness gain is skipped in the step of amending the brightness gain matrix. Namely, the brightness gain would not be amended in the amending step.

When the brightness gain in the brightness gain matrix is between the default color-shift threshold and a first high-brightness threshold gain, the brightness gain is amended to the default color-shift threshold.

When the brightness gain in the brightness gain matrix is between a Nth high-brightness threshold gain and a (N+1)th high-brightness threshold gain, the brightness gain is amended to a product of the Nth high-brightness threshold gain multiplied by an attenuation factor, wherein N is a positive integer more than or equal to one, and the bigger N is, the bigger a value of the attenuation factor is.

Step S105 is according to the brightness gain matrix amended, driving the liquid crystal display.

Optionally, after the step S101, the method for driving a liquid crystal display further comprises the steps of performing a statistic counting to the brightness gain matrix, to obtain a statistical matrix, and setting the default color-shift threshold and the default high-brightness threshold according to the statistical matrix.

For example, a gray level of one image displayed by the liquid crystal display is obtained. The gray level includes a height, a width and values of the gray level of three channels RIG/B, and constitutes a matrix of gray levels, represented as gray (height, width, R/G/B). The matrix of gray levels, gray (height, width, R/G/B), is normalized according to an electric light curve. A Gamma curve is applied to normalize the matrix of gray levels, gray (height, width, R/G/B).

The RGB signal is then transformed to RGBW signal, and a calculation of brightness gain is performed according to a transform function, to obtain the brightness gain matrix. For example, the brightness gain matrix gain (height, width)=f(Rin, Gin, Bin), wherein, Rin/Gin/Bin represent the gray levels of R/G/B input, corresponding to each pixel of the image, and f(x) is a brightness gain function.

The color-shift threshold is set and calculated through the brightness gain matrix, gain (height, width), to obtain the corresponding color-shift threshold gain, represented as gain_threshold. The definition of the color-shift threshold gain is, in the brightness gain matrix, gain (height, width), only a proportion of pixel gains are selected, the proportion is equal to the default color-shift threshold, and the selected pixel gains all are smaller than the color-shift threshold gain.

The high-brightness threshold is set and calculated through the brightness gain matrix, gain (height, width), to obtain the corresponding high-brightness threshold gain. The definition of the high-brightness threshold gain is, in the brightness gain matrix, gain (height, width), only a proportion of pixel gains are selected, the proportion is equal to the default high-brightness threshold, and the selected pixel gains all are larger than the high-brightness threshold gain.

In one embodiment, the number of the default high-brightness threshold is at least one.

The brightness gain matrix is amended according to the color-shift threshold gain and the high-brightness threshold gain.

The step of amending the brightness gain matrix according to the color-shift threshold gain and the high-brightness threshold gain, further comprises the following steps.

When the brightness gain in the brightness gain matrix is smaller than the default color-shift threshold, the brightness gain is skipped in the step of amending the brightness gain matrix. Namely, the brightness gain would not be amended in the amending step.

When the brightness gain in the brightness gain matrix is between the default color-shift threshold and a first high-brightness threshold gain, the brightness gain is amended to the default color-shift threshold.

When the brightness gain in the brightness gain matrix is between a Nth high-brightness threshold gain and a (N+1)th high-brightness threshold gain, the brightness gain is amended to a product of the Nth high-brightness threshold gain multiplied by an attenuation factor, wherein, N is a positive integer more than or equal to one, and the bigger N is, the bigger a value of the attenuation factor is.

Specifically, which of the following is the example of two high-brightness thresholds.

Two high-brightness thresholds, ratio1 and ratio2, are set, and the high-brightness threshold gains corresponding thereto are represented as gain_threshold1 and gain_threshold2.

K1 and K2 represent the attenuation factors, and 0 [symbol] K1<K2 [symbol] 1. The brightness gain matrix gain (height, width) is amended to obtain the amended brightness gain matrix, represented as Gain (height, width). The amended brightness gain matrix is then applied for driving the liquid crystal display.

Specifically, which of the following is the example of N number of the default high-brightness thresholds.

N number of high-brightness thresholds, represented as ratio1, ratio2, . . . ratio (N−1) and ratio N, are set, and the high-brightness threshold gains corresponding thereto are represented as gain_threshold1, gain_threshold2, . . . gain_threshold (N−1) and gain_threshold N.

K1, K2, . . . K (N−1) and K (N) represent the attenuation factors, and 0 [symbol] K1<K2<. . . K (N−1) <K (N) [symbol] 1. The brightness gain matrix gain (height, width) is amended to obtain the amended brightness gain matrix, represented as Gain (height, width). The amended brightness gain matrix is then applied for driving the liquid crystal display.

After the brightness gain matrix is obtained, a statistic counting is performed to the brightness gain matrix, gain (height, width), namely dividing the brightness gain matrix into n equal parts for statistic counting, wherein n may be 50, 100, etc., to obtain the statistical matrix. The default color-shift threshold and the default high-brightness threshold are set according to the statistical matrix.

In the method for driving the liquid crystal display provided by the present invention, the first image signal of the liquid crystal display is transformed to the second image signal including a gain, and the brightness gain of each pixel in an image displayed by the liquid crystal display is obtained according to the second image signal, to obtain the brightness gain matrix. The default color-shift threshold and the default high-brightness threshold are combined for amending the brightness gain matrix. The amended brightness gain matrix is applied to drive the liquid crystal display, for improving the color shift issue when the liquid crystal display is applied to display images.

When the method for driving the liquid crystal display in the present invention is applied to display images, the brightness gain would be reduced for the need to display color images with high color purity, namely the brightness of white sub-pixel would be reduced, thereby to get the color image with higher color purity displayed on the liquid crystal display. On the other hand, the brightness gain would be increased for the need to display white, black or gray colors of images, namely the brightness of white sub-pixel would be increased, thereby to get the images of black, white or gray colors with higher brightness displayed on the liquid crystal display.

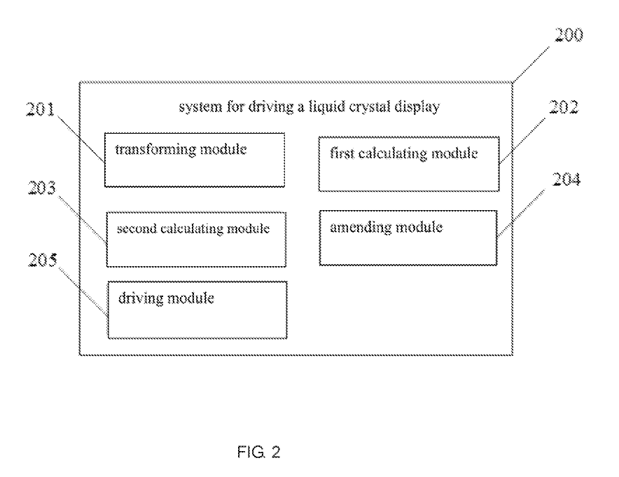

As shown in FIG. 2, a system 200 for driving a liquid crystal display is provided. The system 200 comprises a transforming module 201, a first calculating module 202, a second calculating module 203, an amending module 204 and a driving module 205. The specific functions of each module are described in detail as follows.

The transforming module 201 is for transforming a first image signal input to a liquid crystal display to a second image signal including a gain, and obtaining a brightness gain of each pixel in an image displayed by the liquid crystal display according to the second image signal, to obtain a brightness gain matrix;

The first calculating module 202 is according to a default color-shift threshold, for calculating a color-shift threshold gain corresponding to the default color-shift threshold;

In one embodiment, in the brightness gain matrix only a proportion of pixel gains are selected, the proportion is equal to the default color-shift threshold, and the selected pixel gains all are smaller than the color-shift threshold gain.

The second calculating module 203 is, according to a default high-brightness threshold, for calculating a high-brightness threshold gain corresponding to the default high-brightness threshold;

In one embodiment, in the brightness gain matrix only a proportion of pixel gains are selected, the proportion is equal to the default high-brightness threshold, and the selected pixel gains all are larger than the high-brightness threshold gain.

In one embodiment, the number of the default high-brightness threshold is at least one.

The amending module 204 is, according to the color-shift threshold gain and the high-brightness threshold gain, for amending the brightness gain matrix;

The driving module 205 is, according to the brightness gain matrix amended, for driving the liquid crystal display.

In one embodiment, when the brightness gain in the brightness gain matrix is smaller than the default color-shift threshold, the brightness gain is skipped in the step of amending the brightness gain matrix. Namely, the brightness gain would not be amended in the amending step.

When the brightness gain in the brightness gain matrix is between the default color-shift threshold and a first high-brightness threshold gain, the brightness gain is amended to the default color-shift threshold.

When the brightness gain in the brightness gain matrix is between a Nth high-brightness threshold gain and a (N+1)th high-brightness threshold gain, the brightness gain is amended to a product of the Nth high-brightness threshold gain multiplied by an attenuation factor, wherein N is a positive integer more than or equal to one, and the bigger N is, the bigger a value of the attenuation factor is.

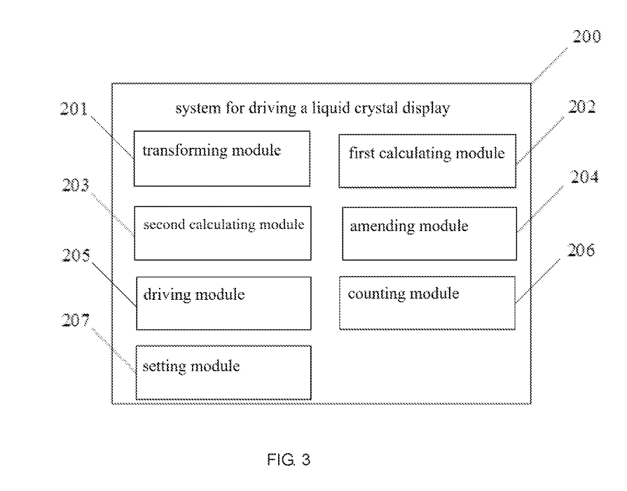

Optionally, as shown in FIG. 3, the system 200 further comprises the following modules.

A counting module 206 is for performing a statistic counting to the brightness gain matrix, to obtain a statistical matrix.

A setting module 207 is for setting the default color-shift threshold and the default high-brightness threshold according to the statistical matrix.

For example, a gray level of one image displayed by the liquid crystal display is obtained. The gray level includes a height, a width and values of the gray level of three channels R/G/B, and constitutes a matrix of gray levels, represented as gray (height, width, R/G/B). The matrix of gray levels, gray (height, width, R/G/B), is normalized according to an electric light curve. A Gamma curve is applied to normalize the matrix of gray levels, gray (height, width, R/G/B).

The RGB signal is then transformed to RGBW signal, and a calculation of brightness gain is performed according to a transform function, to obtain the brightness gain matrix, by the transforming module 201. For example, the brightness gain matrix gain (height, width)=f (Rin, Gin, Bin), wherein, Rin/Gin/Bin represent the gray levels of R/G/B input, corresponding to each pixel of the image, and f(x) is a brightness gain function.

The color-shift threshold is set and calculated through the brightness gain matrix, gain (height, width), to obtain the corresponding color-shift threshold gain, represented as gain_threshold, by the first calculating module 202. The definition of the color-shift threshold gain is, in the brightness gain matrix, gain (height, width), only a proportion of pixel gains are selected, the proportion is equal to the default color-shift threshold, and the selected pixel gains all are smaller than the color-shift threshold gain.

The high-brightness threshold is set and calculated through the brightness gain matrix, gain (height, width), to obtain the corresponding high-brightness threshold gain, by the second calculating module 203. The definition of the high-brightness threshold gain is, in the brightness gain matrix, gain (height, width), only a proportion of pixel gains are selected, the proportion is equal to the default high-brightness threshold, and the selected pixel gains all are larger than the high-brightness threshold gain.

In one embodiment, the number of he default high-brightness threshold is at least one.

The brightness gain matrix is amended according to the color-shift threshold gain and the high-brightness threshold gain, by the amending module 204.

Specifically, which of the following is the example of two high-brightness thresholds.

Two high-brightness thresholds, ratio1 and ratio2, are set, and the high-brightness threshold gains corresponding thereto are represented as gain_threshold1 and gain_threshold2.

K1 and K2 represent the attenuation factors, and 0 [symbol] K1<K2 [symbol] 1. The brightness gain matrix gain (height, width) is amended by the amending module 204 to obtain the amended brightness gain matrix, represented as Gain (height, width). The amended brightness gain matrix is then applied for driving the liquid crystal display by the driving module 205.

Specifically, which of the following is the example of N number of the default high-brightness thresholds.

N number of high-brightness thresholds, represented as ratio1, ratio2, . . . ratio (N−1) and ratio N, are set, and the high-brightness threshold gains corresponding thereto are represented as gain_threshold1, gain_threshold2, . . . gain_threshold (N−1) and gain_threshold N.

K1 K2, . . . K (N−1) and K (N) represent the attenuation factors, and 0 [symbol] K1<K2<. . . K (N−1) <K (N) [symbol] 1. The brightness gain matrix gain(height, width) is amended by the amending module 204 to obtain the amended brightness gain matrix, represented as Gain (height, width). The amended brightness gain matrix is then applied for driving the liquid crystal display by the driving module 205.

The system 200 further comprises a counting module 206 and a setting module 207. The counting module 206 is for performing a statistic counting to the brightness gain matrix, gain (height, width), namely dividing the brightness gain matrix into n equal parts for statistic counting, wherein n may be 50, 100, etc., thereto obtain a statistical matrix. The default color-shift threshold and the default high-brightness threshold are set according to the statistical matrix by the setting module 207.

In the technical solution proposed by the present invention, the steps of transforming the image signal of the liquid crystal display, calculating the brightness gain, and amending the brightness gain matrix by the combination of the default color-shift threshold and the default high-brightness threshold, are applied to improve the utilization rate of the backlight of the liquid crystal display and simultaneously to improve the color shift issue due to uneven brightness gain.

The embodiments in the present invention also provide a computer readable storage medium with a program for driving the liquid crystal display stored therein. The program is executed to perform all or a part of the steps of any method for driving the liquid crystal display depicted in above embodiments.

The embodiments in the present invention also provide a computer program product with a program for driving the liquid crystal display stored therein. The computer program product executes the program to perform a part or all of the steps of any method for driving the liquid crystal display depicted in above embodiments.

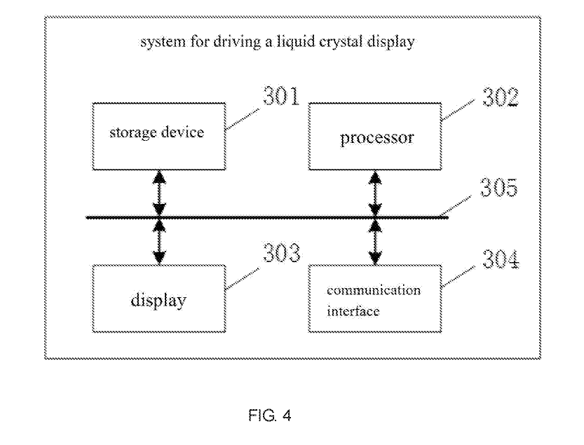

As shown in FIG. 4, a structure scheme of a system for driving the liquid crystal display involved in the above embodiments is provided. The system for driving the liquid crystal display 300 comprises a storage device 301, a processor 302, a display 303, a communication interface 304 and a bus 305. The processor 302 is applied to run or execute the procedures illustrated in FIG. l. The storage device 301, the processor 302, the display 303 and the communication interface 304 are all connected to the bus 305. The bus 305 may be a PCI (Peripheral Component Interconnect) bus, a EISA (Extension Industry Standard Architecture) bus and the like. The bus 305 may be divided into an address bus, a data bus, a control bus and the like. For illustrating conveniently, the bus is represented by only one thick line in FIG. 4, however, it does not mean there is only one bus or only one type of bus.

Those with ordinary skill in the art may understand that all or part of the procedure of the above embodiments can be fulfilled through relevant hardware instructed by a computer program. The program may be stored in a computer readable storage medium. When the program is executed, the procedures including the foregoing method illustrated in embodiments would be performed. The storage medium may be a magnetic disk, an optical disk, read-only memory (ROM) or a random-access memory (RAM) and the like.

It should be noted, for briefly describing, the foregoing method embodiments or examples are described as a series combination of actions. However, those skilled in the art should understand that the present invention is not limited by the described operation sequence, because according to the present invention some steps may be performed simultaneously or in other sequences. Secondly, those skilled in the art should also know that, all the exemplary embodiments described in the specification are optional, and the actions and units involved are not necessarily required by the present invention.

In the above embodiments, the descriptions of the various embodiments have different emphases, certain embodiments not detailed in part can be understood by referring to related descriptions in other embodiments.

In the embodiments provided by the present invention, it could be understood that the disclosed system, apparatus and method may be implemented in other ways. For example, the described system embodiments are merely illustrative, the unit division is merely logical function division, there may be other division in actual implementation. For example, a plurality of units or components may be combined, or be integrated into another system, or some features may be ignored or not performed. Besides, coupling, direct coupling or communication between interconnected may be through some interface, device, or unit, and which may be electrical, mechanical, or other forms.

The unit is described as separated parts may be or may not be physically separated. The parts, illustrated as units, may be or may not be physical units. Namely, the parts may be located in one place, or may be distributed to multiple network units. All or some of the units can be selected according to actual needs to achieve the object of the solutions of the embodiments.

Further, each of the functional units in the respective embodiments disclosed in the present process can be integrated into one unit or may be physically separated units, and may be two or more units integrated into one unit. The integrated unit may be implemented in the form of hardware or software functional module.

If the integrated unit is implemented in the form of a software functional module and as an independent product for sale or use, the software functional module may be stored in a computer-readable storage medium. Based on this understanding, the technical solutions or the part that makes contributions to the prior art of the present invention can be substantially embodied in the form of a software product. The computer software product may be stored in one or more storage media and contain several instructions adapted to instruct computer equipment (for example, a personal computer, a server, or network equipment) to perform the methods according to the embodiments of the present invention. The storage medium comprising: a variety of medium U disk, mobile hard disk, a read-only memory (ROM), a random-access memory (RAM), a magnetic disk, or an optical disc capable of storing program code.

Those with ordinary skill in the art may understand that all or part of the steps of various methods proposed by the above embodiments can be fulfilled through relevant hardware instructed by a computer program. The program may be stored in a computer readable storage medium. The storage medium may be a flash memory, a read-only memory (ROM), a random-access memory (RAM), a magnetic disk, an optical disc and the like.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A method for driving a liquid crystal display, comprising:
transforming a first image signal input to a liquid crystal display to a second image signal including a gain, and obtaining a brightness gain of each pixel in an image displayed by the liquid crystal display according to the second image signal, to obtain a brightness gain matrix;
according to a default color-shift threshold, calculating a color-shift threshold gain corresponding to the default color-shift threshold;
according to a default high-brightness threshold, calculating a high-brightness threshold gain corresponding to the default high-brightness threshold;
according to the color-shift threshold gain and the high-brightness threshold gain, amending the brightness gain matrix; and
according to the brightness gain matrix amended, driving the liquid crystal display.

2. The method for driving the liquid crystal display according to claim 1, further comprising:
performing a statistic counting to the brightness gain matrix, to obtain a statistical matrix; and
setting the default color-shift threshold and the default high-brightness threshold according to the statistical matrix.

3. The method for driving the liquid crystal display according to claim 1, wherein in the brightness gain matrix only a first proportion of pixel gains are selected, the first proportion is equal to the default color-shift threshold and the selected pixel gains all are smaller than the color-shift threshold gain; and
in the brightness gain matrix only a second proportion of the pixel gains are selected, the second proportion is equal to the default high-brightness threshold and the selected pixel gains all are larger than the high-brightness threshold gain.

4. The method for driving the liquid crystal display according to claim 1, wherein, the step of amending the brightness gain matrix according to the color-shift threshold gain and the high-brightness threshold gain, further comprises:
when the brightness gain in the brightness gain matrix is smaller than the default color-shift threshold, skipping the brightness gain in the step of amending the brightness gain matrix;
when the brightness gain in the brightness gain matrix is between the default color-shift threshold and a first high-brightness threshold gain, amending the brightness gain to the default color-shift threshold; and
when the brightness gain in the brightness gain matrix is between a Nth high-brightness threshold gain and a (N+1)th high-brightness threshold gain, amending the brightness gain to a product of the Nth high-brightness threshold gain multiplied by an attenuation factor, wherein, N is a positive integer more than or equal to one, and the bigger N is, the bigger a value of the attenuation factor is.

5. A system for driving a liquid crystal display, comprising:
a transforming module, for transforming a first image signal input to a liquid crystal display to a second image signal including a gain, and obtaining a brightness gain of each pixel in an image displayed by the liquid crystal display according to the second image signal, to obtain a brightness gain matrix;
a first calculating module, according to a default color-shift threshold, for calculating a color-shift threshold gain corresponding to the default color-shift threshold;
a second calculating module, according to a default high-brightness threshold, for calculating a high-brightness threshold gain corresponding to the default high-brightness threshold;
an amending module, according to the color-shift threshold gain and the high-brightness threshold gain, for amending the brightness gain matrix; and
a driving module, according to the brightness gain matrix amended, for driving the liquid crystal display.

6. The system for driving the liquid crystal display according to claim 5, further comprising:
a counting module, for performing a statistic counting to the brightness gain matrix, to obtain a statistical matrix; and
a setting module, for setting the default color-shift threshold and the default high-brightness threshold according to the statistical matrix.

7. The system for driving the liquid crystal display according to claim 5, wherein in the brightness gain matrix only a first proportion of pixel gains are selected, the first proportion is equal to the default color-shift threshold and the selected pixel gains all are smaller than the color-shift threshold gain; and
in the brightness gain matrix only a second proportion of pixel gains are selected, the second proportion is equal to the default high-brightness threshold and the selected pixel gains all are larger than the high-brightness threshold gain.

8. The system for driving the liquid crystal display according to claim 5, wherein the number of the default high-brightness threshold is at least one.

9. The system for driving the liquid crystal display according to claim 5, wherein the amending module is applied for
when the brightness gain in the brightness gain matrix is smaller than the default color-shift threshold, skipping the brightness gain in the step of amending the brightness gain matrix;
when the brightness gain in the brightness gain matrix is between the default color-shift threshold and a first high-brightness threshold gain, amending the brightness gain to the default color-shift threshold; and
when the brightness gain in the brightness gain matrix is between a Nth high-brightness threshold gain and a (N+1)th high-brightness threshold gain, amending the brightness gain to a product of the Nth high-brightness threshold gain multiplied by an attenuation factor, wherein, N is a positive integer more than or equal to one, and the bigger N is, the bigger a value of the attenuation factor is.

10. A computer readable storage medium with a program for driving the liquid crystal display stored therein, wherein the program is executed to perform the steps comprising:
transforming a first image signal input to a liquid crystal display to a second image signal including a gain, and obtaining a brightness gain of each pixel in an image displayed by the liquid crystal display according to the second image signal, to obtain a brightness gain matrix;
according to a default color-shift threshold, calculating a color-shift threshold gain corresponding to the default color-shift threshold;
according to a default high-brightness threshold, calculating a high-brightness threshold gain corresponding to the default high-brightness threshold;
according to the color-shift threshold gain and the high-brightness threshold gain, amending the brightness gain matrix; and
according to the brightness gain matrix amended, driving the liquid crystal display.

11. The computer readable storage medium according to claim 10, wherein the method for driving the liquid crystal display, further comprises:
performing a statistic counting to the brightness gain matrix, to obtain a statistical matrix; and
setting the default color-shift threshold and the default high-brightness threshold according to the statistical matrix.

12. The computer readable storage medium according to claim 10, wherein in the brightness gain matrix only a first proportion of pixel gains are selected, the first proportion is equal to the default color-shift threshold and the selected pixel gains all are smaller than the color-shift threshold gain; and
in the brightness gain matrix only a second proportion of pixel gains are selected, the second proportion is equal to the default high-brightness threshold and the selected pixel gains all are larger than the high-brightness threshold gain.

13. The computer readable storage medium according to claim 10, wherein the step of amending the brightness gain matrix according to the color-shift threshold gain and the high-brightness threshold gain, further comprises;
when the brightness gain in the brightness gain matrix is smaller than the default color-shift threshold, skipping the brightness gain in the step of amending the brightness gain matrix;
when the brightness gain in the brightness gain matrix is between the default color-shift threshold and a first high-brightness threshold gain, amending the brightness gain to the default color-shift threshold; and
when the brightness gain in the brightness gain matrix is between a Nth high-brightness threshold gain and a (N+1)th high-brightness threshold gain, amending the brightness gain to a product of the Nth high-brightness threshold gain multiplied by an attenuation factor, wherein, N is a positive integer more than or equal to one, and the bigger N is, the bigger a value of the attenuation factor is.
